(19) United States
(12) Patent Application Publication
(10) Pub. No.: US 2025/0106668 A1
(43) Pub. Date: Mar. 27, 2025

(54) MEASUREMENTS FOR ONE OR MORE INTER-CELL PURPOSES

(71) Applicant: Nokia Technologies Oy, Espoo (FI)

(72) Inventors: Lars DALSGAARD, Oulu (FI); Daejung YOON, Massy (FR); Tero HENTTONEN, Espoo (FI); Timo KOSKELA, Oulu (FI)

(73) Assignee: Nokia Technologies Oy, Espoo (FI)

(21) Appl. No.: 18/852,612

(22) PCT Filed: Apr. 8, 2022
(86) PCT No.: PCT/EP2022/059355

§ 371 Date: Sep. 30, 2024

(51) Int. Cl. H04W 24/10; H04L 5/00

(52) U.S. Cl. CPC H04W 24/10; H04L 5/0048

(57) ABSTRACT

A first apparatus may be configured, over a serving cell, to indicate to a second apparatus controlling the operation of the serving cell, a suitability of a non-serving cell for one or more inter-cell purposes. For example, the first apparatus may receive from the second apparatus Layer 3, L3, measurement configuration information including a criterion for one or more first inter-cell purposes. When the first apparatus detects, based on performed L3 measurements of one or more reference signals in one or more non-serving cells that the criterion is met for L3 measurements of a first reference signal in a first non-serving cell, the first apparatus transmits a measurement report indicating that the first non-serving cell is a suitable cell for performing L1 measurements by the first apparatus for one or more second inter-cell purposes.

### TECHNICAL FIELD

Various example embodiments relate to wireless communications.

### BACKGROUND

Wireless communication systems are under constant development, including enhancement to existing features, for example multiple-input multiple-out-put enhancements and beamforming enhancements and different inter-cell scenarios.

### BRIEF DESCRIPTION

The subject matter of the independent claims defines the scope.

According to an aspect there is provided a first apparatus comprising at least one processor; and at least one memory including computer program code, the at least one memory and computer program code being configured to, with the at least one processor, cause the first apparatus to: receive, from a second apparatus controlling the operation of a serving cell, Layer 3, L3, measurement configuration information including a criterion which L3 measurements of a reference signal in a non-serving cell shall meet to indicate that the non-serving cell is a suitable cell for performing Layer 1, L1, measurements by the first apparatus for one or more first inter-cell purposes; perform L3 measurements of one or more reference signals in one or more non-serving cells; when the criterion is met for L3 measurements of a first reference signal in a first non-serving cell, transmit a measurement report indicating that the first non-serving cell is a suitable cell for performing L1 measurements by the first apparatus for one or more second inter-cell purposes.

In embodiments, the L3 measurement configuration information further includes the one or more first inter-cell purposes for which L1 measurements in the non-serving cell are usable.

In embodiments, the measurement report further includes the one or more second inter-cell purposes for which L1 measurements in the first non-serving cell are usable.

In embodiments, the one or more second inter-cell purposes are selected from the one or more first inter-cell purposes.

In embodiments, the one or more second inter-cell purposes are selected based on capabilities of the first apparatus to operate according to the one or more second inter-cell purpose.

In embodiments, the one or more first and second inter-cell purposes comprise at least one of inter-cell beam management, physical layer mobility, medium access layer mobility, and inter-cell multiple transmission-reception points.

In embodiments, the at least one memory and computer program code are configured to, with the at least one processor, further cause the first apparatus to: receive, in the measurement configuration information, a further criterion which L3 measurements of a reference signal in a non-serving cell shall meet to indicate that the non-serving cell is no longer a suitable cell for performing Layer 1, L1, measurements by the first apparatus for the one or more first inter-cell purposes; when the further criterion is met for L3 measurements of the first reference signal, transmit a further measurement report indicating that the first non-serving cell is no longer a suitable cell for performing L1 measurements by the first apparatus for the one or more second inter-cell purposes.

In embodiments, the measurement report is for reporting L3 measurements.

In embodiments, the first non-serving cell is configured as a candidate cell for the at least one inter-cell purposes.

In embodiments, the L3 measurements are configurable by means of radio resource control protocol, and/or the L3 measurements are averaged over a first time period and the L1 measurements are averaged over a second time period.

According to an aspect there is provided a second apparatus comprising at least one processor; and at least one memory including computer program code, the at least one memory and computer program code being configured to, with the at least one processor, cause the second apparatus to: control the operation of a serving cell; transmit, to a first apparatus, Layer 3, L3, measurement configuration information including a criterion which L3 measurements of a reference signal in a non-serving cell shall meet to indicate that the non-serving cell is a suitable cell for performing Layer 1, L1, measurements by the first apparatus for one or more first inter-cell purposes; receive a measurement report indicating that the first non-serving cell is a suitable cell for performing L1 measurements by the first apparatus for one or more second inter-cell purposes.

In embodiments, the L3 measurement configuration information further includes the one or more first inter-cell purposes for which L1 measurements in the non-serving cell are usable.

In embodiments, the measurement report further includes the one or more second inter-cell purposes for which L1 measurements in the first non-serving cell are usable.

in embodiments, the at least one memory and computer program code are configured to, with the at least one processor, further cause the second apparatus to transmit, in the measurement configuration information, a further criterion which L3 measurements of a reference signal in a non-serving cell shall meet to indicate that the non-serving cell is no longer a suitable cell for performing Layer 1, L1, measurements by the first apparatus for the one or more first inter-cell purposes; receive a further measurement report indicating that the first non-serving cell is no longer a suitable cell for performing L1 measurements by the first apparatus for the one or more second inter-cell purposes.

According to an aspect there is provided a method comprising: receiving, in a first apparatus, from a second apparatus controlling the operation of a serving cell, Layer 3, L3, measurement configuration information including a criterion which L3 measurements of a reference signal in a non-serving cell shall meet to indicate that the non-serving cell is a suitable cell for performing Layer 1, L1, measurements by the first apparatus for one or more first inter-cell purposes; performing by the first apparatus L3 measurements of one or more reference signals in one or more non-serving cells; when the criterion is met for L3 measurements of a first reference signal in a first non-serving cell, transmitting from the first apparatus a measurement report indicating that the first non-serving cell is a suitable cell for performing L1 measurements by the first apparatus for one or more second inter-cell purposes.

According to an aspect there is provided a method comprising: controlling, by a second apparatus, the operation of a serving cell; transmitting, from the second apparatus to a first apparatus, Layer 3, L3, measurement configuration information including a criterion which L3 measurements of a reference signal in a non-serving cell shall meet to indicate that the non-serving cell is a suitable cell for performing Layer 1, L1, measurements by the first apparatus for one or more first inter-cell purposes; and receiving, by the second apparatus, a measurement report indicating that the first non-serving cell is a suitable cell for performing L1 measurements by the first apparatus for one or more second inter-cell purposes.

### BRIEF DESCRIPTION OF DRAWINGS

Embodiments are described below, by way of example only, with reference to the accompanying drawings, in which

FIGS. 1 and 2 illustrate exemplified wireless communication systems;

FIGS. 3 and 4 illustrate exemplified information exchange;

FIGS. 5 to 8 are flow charts illustrating examples of functionalities; and

FIGS. 9 and 10 are schematic block diagrams.

### DETAILED DESCRIPTION OF SOME EMBODIMENTS

The following embodiments are examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned. Further, although terms including ordinal numbers, such as “first”, “second”, etc., may be used for describing various elements, the structural elements are not restricted by the terms. The terms are used merely for the purpose of distinguishing an element from other elements. For example, a first inter-cell purpose could be termed a second inter-cell purpose, and similarly, a second inter-cell purpose could be also termed a first inter-cell purpose without departing from the scope of the present disclosure.

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. The embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

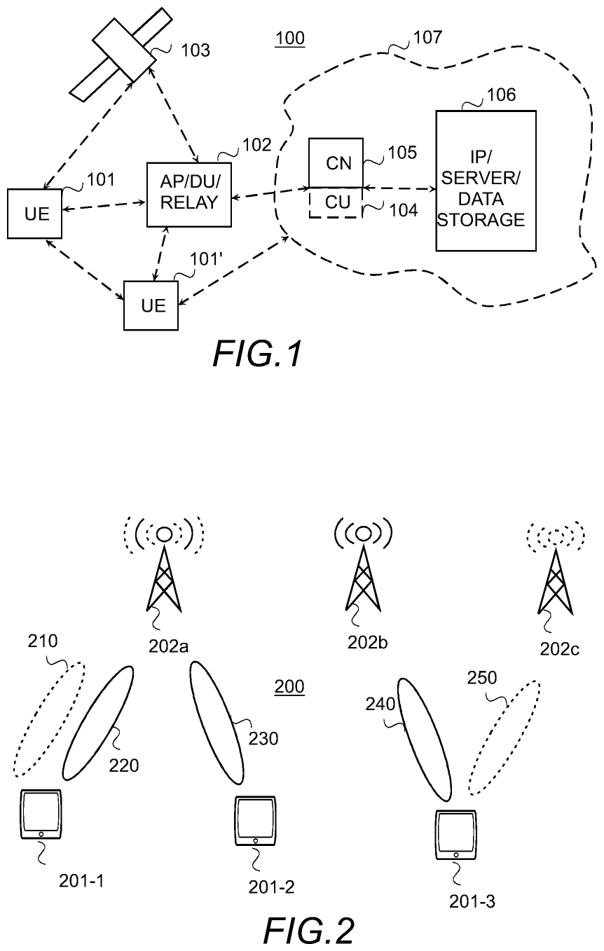

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system 100 given as an example but a person skilled in the art may apply the solution to other communication systems provided with necessary properties. The example of FIG. 1 shows a part of an exemplifying radio access network.

FIG. 1 shows user devices 101, 101′ configured to be in a wireless connection on one or more communication channels with a node 102. The node 102 is further connected to a core network 105. In one example, the node 102 may be an access node such as (e/g) NodeB providing or serving devices in a cell. In one example, the node 102 may be a non-3GPP access node. The physical link from a device to a (e/g) NodeB is called uplink or reverse link and the physical link from the (e/g) NodeB to the device is called downlink or forward link. It should be appreciated that (e/g) NodeBs or their functionalities may be implemented by using any node, host, server or access point etc. entity suitable for such a usage.

A communications system typically comprises more than one (e/g) NodeB in which case the (e/g) NodeBs may also be configured to communicate with one another over links, wired or wireless, designed for the purpose. These links may be used for signalling purposes. The (e/g) NodeB is a computing device configured to control the radio resources of communication system it is coupled to. The NodeB may also be referred to as a base station, an access point or any other type of interfacing device including a relay station capable of operating in a wireless environment. The (e/g) NodeB includes or is coupled to transceivers. From the transceivers of the (e/g) NodeB, a connection is provided to an antenna unit that establishes bi-directional radio links to devices. The antenna unit may comprise a plurality of antennas or antenna elements. The (e/g) NodeB is further connected to the core network 105 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), or access and mobility management function (AMF), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a device (e.g. a portable or non-portable computing device) that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a device may also be a nearly exclusive uplink only device, of which an example is a camera or video camera loading images or video clips to a network. A device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The user device may also utilize cloud. In some applications, a user device may comprise a user portable device with radio parts (such as a watch, earphones, eyeglasses, other wearable accessories or wearables) and the computation is carried out in the cloud. The device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors micro-controllers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input—multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz—cmWave, below 6 GHz—cmWave—mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 106, or utilise services provided by them. The communication network may also be able to support the usage of cloud services, for example at least part of core network operations may be carried out as a cloud service (this is depicted in FIG. 1 by “cloud” 107). The communication system may also comprise a central control entity, or a like, providing facilities for networks of different operators to cooperate for example in spectrum sharing.

The technology of Edge cloud may be brought into a radio access network (RAN) by utilizing network function virtualization (NVF) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 102) and non-real time functions being carried out in a centralized manner (in a centralized unit, CU 104).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano) satellites are deployed). Each satellite 103 in the mega-constellation may cover several satellite-enabled network entities that create on-ground cells. The on-ground cells may be created through an on-ground relay node 102 or by a gNB located on-ground or in a satellite.

It is obvious for a person skilled in the art that the depicted system is only an example of a part of a radio access system and in practice, the system may comprise a plurality of (e/g) NodeBs, the user device may have an access to a plurality of radio cells and the system may comprise also other apparatuses, such as physical layer relay nodes or other network elements, etc. At least one of the (e/g) NodeBs or may be a Home (e/g) nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto-or picocells. The (e/g) NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g) NodeBs are required to provide such a network structure.

For fulfilling the need for improving the deployment and performance of communication systems, the concept of “plug-and-play” (e/g) NodeBs has been introduced. Typically, a network which is able to use “plug-and-play” (e/g) Node Bs, includes, in addition to Home (e/g) NodeBs (H (e/g) nodeBs), a home node B gateway, or HNB-GW (not shown in FIG. 1). A HNB Gateway (HNB-GW), which is typically installed within an operator's network may aggregate traffic from a large number of HNBs back to a core network.

It is envisaged that in 5G, 6G and beyond, inter-cell beam management and multiple transmission-reception points may be utilized to serve a user device, or shortly a device or a first apparatus, for improving reliability, coverage, and capacity performance through flexible deployment scenarios. It also envisaged that there will be different types of devices with different capabilities.

FIG. 2 illustrates a zoom view of a radio access system 200 illustrated in FIG. 1. Referring to FIG. 2, in the illustrated example the radio access network 200 provides wireless interface (wireless access) to first apparatuses, depicted in FIG. 2 by three user devices 201-1, 201-2, 201-3, by means of one or more second apparatuses 202a, 202b, 202c.

One or more of the second apparatuses 202a, 202b, 202c may be an apparatus, for example a base station or corresponding access node, that is configured to control operation of one or more cells provided by said apparatus, and/or configured to control operation of one or more cells provided by one or more other second apparatuses, called herein transmission-reception points. A transmission-reception point may be a base station or another access node, or an operational entity comprising one or more antennas in a base station, or an operational entity comprising one or more remote radio heads, or a remote antenna of a base station, or any other set of geographically co-located antennas forming one operational entity, for example an antenna array with one or more antenna elements, for one cell in the radio access network 200, or for a part of the one cell. In other words, one cell may include one or multiple transmission points, and cells in the radio access network comprise transmission-reception points. One of the multiple transmission-reception points may be provided by said apparatus configured to control operation of one or more cells.

The first apparatuses 201-1, 201-2, 201-3 may have different capabilities, either as configured, preset and/or depending on other conditions, for example a location. For example, a first apparatus 201-1, 201-2, 201-3 may be capable to operate with beams 210, 220, 240, 250 by means of independent or common beam management, depending on the first apparatus's current location, capabilities and other conditions. In the example illustrated in FIG. 2, the first apparatus 201-1 is operable in its current position with two inter-cell beams 210, 220 of two respective cells provided by the second apparatus 202a, and the first apparatus 201-3 is operable in its current position with two inter-cell beams, a beam 240 in a cell provided by the second apparatus 202b and a beam 250 in a cell provided by the second apparatus 202c, whereas the first apparatus 201-2 is operable in its current position with one beam 230.

The apparatus controlling the operation of a serving cell of a device may configure the first apparatus with downlink signal measurement procedures, including when to report measurement results and/or measurement events. For the inter-cell scenario, to avoid unnecessary measurements, for example to minimize power consumption of the device and to avoid a possible negative impact on scheduling availability, the first apparatus may be configured, for example using a radio resource control protocol, as described below.

In the illustrated examples it is assumed, for the sake of clarity of description, that the first apparatus, has one serving cell and other cells are non-serving cells to the first apparatus. When there are more than one serving cell, one of them may be configured to be a primary serving cell to the first apparatus, or the first apparatus may be configured to interpret a currently serving cell to be at the time the primary serving cell, and the first apparatus may be configured to interpret the other serving cells, for example configured as secondary serving cells to the first apparatus, as non-serving cells for the purposes disclosed herein. A non-serving cell (or neighboring cell) is a cell with a physical cell identity that is different from a physical cell identity of the serving cell. The non-serving cell may operate on the same of different frequency as the serving cell. It is straightforward to implement the examples to implementations where there are non-serving cells and two or more serving cells. Further, in the examples below, measurements and reporting relating to serving cell or other events/configurations are not discussed but may be performed.

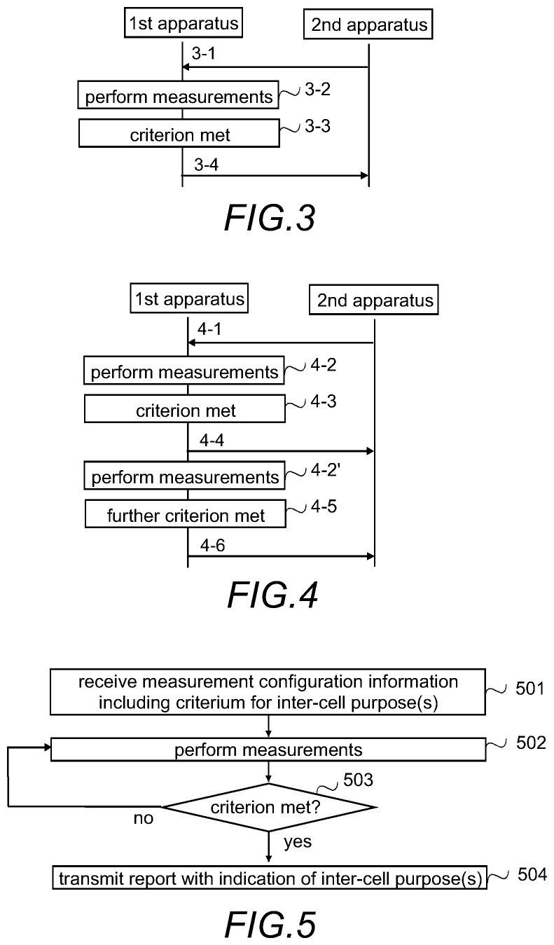

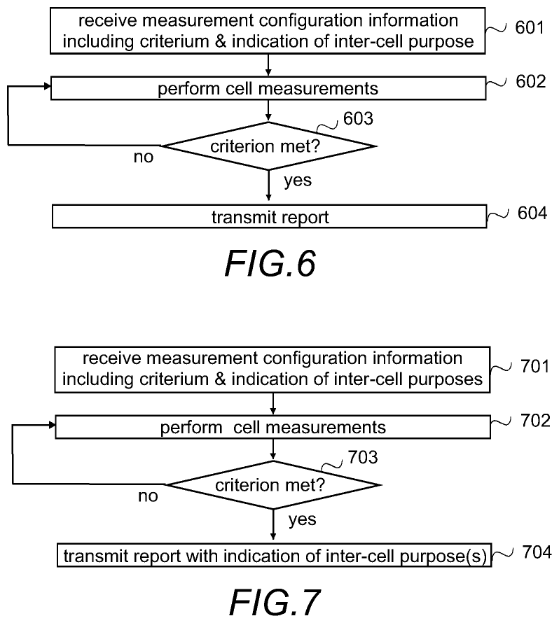

Referring to FIG. 3, the second apparatus (2nd apparatus) configures the first apparatus (1st apparatus) by transmitting message 3-1. Message 3-1 contains measurement configuration information including a criterion which L3 measurements of a reference signal in a non-serving cell shall meet to indicate that the non-serving cell is a suitable cell for performing Layer 1, L1, measurements by the first apparatus for one or more first inter-cell purposes. The L1 measurements may be any physical layer measurements, for example L1 beam measurements. A non-limiting list of inter-cell purposes includes inter-cell beam management, physical layer mobility, medium access layer mobility and inter-cell multiple transmission-reception points operation. The information in message 3-1 may or may not comprise indication of the one or more first inter-cell purposes, as will be described in more detail with FIGS. 5 to 8. The information may be given as a dedicated L3 event, for example an A4A event (the event may be named differently), or by adding one or more new information fields to an L3 event used for another purpose, for instance for L3 mobility. Using a dedicated event facilitates maintaining network settings orthogonal with other events. In any case, an L3 event is used for indicating L1 measurement and/or L1 measurement related reporting capability.

Upon receiving message 3-1 the first apparatus performs in block 3-2 L3 measurements of one or more reference signals in one or more non-serving cells. The first apparatus may also perform L3 measurements in a serving cell. For example, the first apparatus may be configured to measure reference signals received power (RSRP) and/or reference signals received quality (RSRQ). A non-limiting list of possible reference signals to one or more of which to measure include synchronization signal block (SSB) and channel sensing information reference signal (CSI-RS). The measurements may include intra-frequency, inter-frequency and/or inter-RAT (inter-radio access technologies) measurements. Further, one or more of the non-serving cells may have been configured, for example in message 3-1, to be a candidate cell for at least one inter-cell purpose.

In the illustrated example it is assumed that the criterion is met in block 3-3 for L3 measurements of a first reference signal in a first non-serving cell. For example, a power level in the first non-serving cell which the first apparatus can use for one or more inter-cell purposes, exceeds a threshold determined based on the information received in message 3-1, and hence the criterion is met. In another example, the criterion is met when the first non-serving cell is detected. In another example the criterion is met when the first non-serving cell is detected and one or more additional conditions, for example that the cell is above a certain power level and/or signal quality is above a threshold, is fulfilled. In another example, the criterion is fulfilled when the first non-serving cell is detected, and its power level compared to another cell is above a threshold. It should be appreciated that the criterion may not be considered as being met if the first apparatus is not capable for the one or more inter-cell purposes.

Since the criterion is met, the first apparatus transmits a measurement report (message 3-4) indicating that the first non-serving cell is a suitable cell for performing L1 measurements by the first apparatus for one or more second inter-cell purposes. Since the first apparatus is capable to operate according to the one or more second inter-cell purposes (otherwise the criterion would not be considered as being met), one may say that the second inter-cell purposes may be selected based on capabilities of the first apparatus to operate according to the one or more second inter-cell purpose. The measurement report (message 3-4) may or may not comprise indication of the one or more second inter-cell purposes, as will be described in more detail with FIGS. 5 to 8. The measurement report may contain a dedicated event report indicating that the first non-serving cell is a suitable cell for performing L1 measurements by the first apparatus for one or more second inter-cell purposes, or one or more information fields in an L3 event report intended for another purpose may be used for conveying corresponding information. In other words, an L3 measurement report for reporting L3 measurement is used for L1 measurement related reporting.

In an implementation, message 3-4 may comprise additional information on capabilities of the first apparatus for the operation, for example specific capabilities compared to the current configuration in use in the first apparatus.

When the second apparatus receives the measurement report 3-4, the second apparatus becomes aware that the first apparatus is capable, for example since the first apparatus is in the vicinity of the first cell, to use the first cell for the one or more second inter-cell purposes, and/or to perform corresponding L1 measurements, if and/or when needed.

FIG. 4 illustrates another example of information exchange. In the example of FIG. 4, the second apparatus configures the first apparatus by transmitting message 4-1. In the example, message 4-1 contains measurement configuration information including a criterion and a further criterion. It should be appreciated that in implementations using the further criterion, the further criterion may be sent in a separate message, at any time. The criterion may be similar as described above with message 3-1, i.e. a criterion which L3 measurements of a reference signal in a non-serving cell shall meet to indicate that the non-serving cell is a suitable cell for performing L1 measurements, for example L1 beam measurements, or any physical layer measurements, by the first apparatus for one or more first inter-cell purposes. The criterion may be called an entering condition (enter condition). The further criterion is an additional criterion which L3 measurements of a reference signal in a non-serving cell shall meet to indicate that the non-serving cell is no longer a suitable cell for performing L1 measurements by the first apparatus for the one or more first inter-cell purposes. The further criterion may be called a leaving condition (leave condition). Message 4-1 may or may not comprise indication of the one or more first inter-cell purposes, as will be described in more detail with FIGS. 5 to 8. The information may be given as a dedicated event, for example the A4A event, or by adding one or more new information fields to an L3 event used for another purpose, as described above with FIG. 3.

Upon receiving message 4-1 the first apparatus performs in block 4-2 L3 measurements of one or more reference signals in one or more non-serving cells, as described above with FIG. 3.

In the illustrated example of FIG. 4, similar to the example of FIG. 3, it is assumed that the criterion is met in block 4-3 for L3 measurements of a first reference signal in a first non-serving cell. Non-limiting list of examples when the criterion may be met is given above with FIG. 3.

Since the criterion is met, the first apparatus transmits a measurement report (message 4-4) indicating that the first non-serving cell is a suitable cell for performing L1 measurements by the first apparatus for one or more second inter-cell purposes. The measurement report (message 4-4) may or may not comprise indication of the one or more second inter-cell purposes, as will be described in more detail with FIGS. 5 to 8. The measurement report may contain a dedicated event report, or one or more information fields in an L3 event report intended for another purpose may be used for conveying corresponding information. In other words, the measurement report (message 4-4) may correspond to the measurement report (message 3-4) described above.

When the second apparatus receives the measurement report 4-4, the second apparatus becomes aware that the first apparatus is capable to use the first cell for the one or more second inter-cell purposes, and/or to perform corresponding L1 measurements, if and/or when needed.

The first apparatus continues performing measurements (block 4-2) according to the received measurement configuration, and in the illustrated example of FIG. 4, the further criterion is met in block 4-5. For example, the first apparatus may have changed a location and/or a power level of the first reference signal is below a further threshold, and/or the first reference signal is not any more detectable, resulting that the first cell is not any more usable by the first apparatus for one or more inter-cell purposes.

Since the further criterion is met, the first apparatus transmits a further measurement report (message 4-6) indicating that the first non-serving cell is no longer a suitable cell for performing L1 measurements by the first apparatus for the one or more second inter-cell purposes. The further measurement report (message 4-6) may or may not comprise indication of the one or more second inter-cell purposes. The further measurement report may contain a dedicated event report, for example the A4A event report, or one or more information fields in an L3 event report intended for another purpose may be used for conveying corresponding information.

When the second apparatus receives the further measurement report 4-6, the second apparatus becomes aware that the first apparatus is not any more capable to use the first cell for the one or more second inter-cell purposes.

To elaborate more the information exchange in FIG. 4, a non-limiting use case example relating to inter-cell multiple transmission-reception, mTRP, be that a co-located mTRP reception or a non co-located mTRP reception,, is discussed below. Message 4-1 may be a measurement configuration message comprising “Event A4A” with entering and leaving conditions. The second apparatus may also transmit to the first apparatus in a separate message an inter-cell mTRP configuration to the first apparatus, but that is not illustrated in FIG. 4. The first apparatus may, after receiving message 4-1, monitor and measure synchronization signal block, SSB, transmissions from one or more non-serving cells. (The first apparatus may monitor and measure, also or instead, channel state information reference signal transmissions from the one or more non-serving cells. The first apparatus may also measure transmissions from a serving cell.) When an SSB transmission from a first cell, which is a non-serving cell and which can be used by the first apparatus for mTRP reception, fulfils the entering condition, event A4A, or entry event A4A may be triggered (block 4-3) and message 4-4 is transmitted. Message 4-4 may be an L3 measurement report comprising measurement event A4A, including the physical cell identifier of the first cell and possibly one or more identifiers, for example SSB indexes, of a corresponding beam in the first cell that meets the criterion with “enter” indication. It should be appreciated that a cell which cannot be used for mTRP reception may be reported using one or more other events for different purpose. When the second apparatus receives message 4-4, the second apparatus, or the wireless network, is aware that the first apparatus has detected the first cell and is capable of mTRP reception using the first cell, including, for example, performing L1 measurements on the first cell. The first apparatus may then continue to monitor and measure synchronization signal block, SSB, transmissions in the first cell, and when the SSB transmission from the first cell, which has been previously reported as meeting the entering condition, fulfils the leaving condition, event A4A, or leave event A4A, may be triggered (block 4-5) and message 4-6 is transmitted. Message 4-6 may be an L3 measurement report comprising event A4A with physical cell identifier of the first cell, and possibly including the SSB index of the corresponding beam in the first cell with “leave” indication. When the second apparatus receives message 4-6, the second apparatus, or the wireless network, is aware that the first apparatus is not anymore capable of mTRP reception using the first cell. The same principles can be used for any inter-cell purpose, and even in implementations without specific entering and leaving conditions. As can be seen, the disclosed measurement configuration to report cells suitable for one or more inter-cell purposes makes it possible to the wireless network, or the second apparatus, to for example request inter-cell related L1 measurements from a cell which the first apparatus can actually use also for the one or more inter-cell purposes in case the wireless network, or the second apparatus, chooses to use the reported non-serving cell. That ensures that first apparatuses are not configured in vain to measure and report cells that they cannot use for the intended use.

FIGS. 5 to 8 describe different possibilities what messages 3-1, 4-1, 3-4, and 4-4 may contain. In the illustrated examples it is assumed, for the sake of clarity and completeness of the description, that during L3 measurements the criterion is met and reported. It should be appreciated that even though not illustrated in FIGS. 5 to 8, measuring and reporting continues according to measurement configuration after a measurement report is transmitted, at least until a new measurement configuration replacing the existing one is received.

Referring to FIG. 5, in the illustrated example the first apparatus receives in block 501, from the second apparatus, measurement configuration information including a criterion for one or more inter-cell purposes. In the example of FIG. 5, the measurement configuration information does not comprise any specific indication of the one or more inter-cell purposes. For example, the measurement configuration information may comprise A4A event with the criterion, but without further indication of inter-cell purposes. This means that the indirectly indicated one or more first inter-cell purposes in the measurement configuration information cover all or any inter-cell purposes, or one or more pre-agreed or pre-configured inter-cell purposes.

The first apparatus performs (block 502) L3 measurements as configured and if the criterion is met (block 503: yes) for one or more inter-cell purpose, the first apparatus transmits in block 504 a measurement report indicating the one or more inter-cell purposes.

Referring to FIG. 6, in the illustrated example the first apparatus receives in block 601 from the second apparatus measurement configuration information including a criterion for one or more first inter-cell purposes. In the example of FIG. 6, the measurement configuration information also includes the one or more first inter-cell purposes.

The first apparatus performs (block 602) L3 measurements as configured until the criterion is met (block 603: yes). In the example of FIG. 6 it is assumed that the criterion is met when the first apparatus is capable to use the first cell for the one or more inter-cell purposes included in the measurement configuration information. Then the first apparatus transmits in block 604 a measurement report to the second apparatus. However, in the illustrated example the measurement report does not contain any specific indication of inter-cell specific purposes, since they are the ones the measurement configuration information indicated (i.e. the one or more first inter-cell specific purposes). Hence the second apparatus is aware of what the second inter-cell purposes are.

Referring to FIG. 7, in the illustrated example the first apparatus receives in block 701 from the second apparatus measurement configuration information including a criterion for one or more first inter-cell purposes. In the example of FIG. 7, the measurement configuration information also includes the one or more first inter-cell purposes.

The first apparatus performs (block 702) L3 measurements as configured until the criterion is met (block 703: yes). In the example of FIG. 7 it is assumed that the criterion is met when the first apparatus is capable to use the first cell for at least one of the one or more first inter-cell purposes included in the measurement configuration information. Then the first apparatus transmits in block 704 a measurement report to the second apparatus with indication of one or more second inter-cell purpose. By adding to the report the indication of the one or more second inter-cell purpose(s), it is ensured that the second apparatus is aware of the inter-cell purposes the first apparatus can actually support, especially in case the second inter-cell purpose(s) is a (strict) subset of the first inter-cell purposes.

In another implementation, based on FIG. 7, the criterion may be met (block 703: yes) when the first apparatus is capable to use the first cell for any of the one or more first inter-cell purpose, regardless of whether the one or more first inter-cell purpose was included in the measurement configuration information. By adding to the report transmitted in block 704 the indication of the one or more second inter-cell purpose(s), it is ensured that the second apparatus is aware of the inter-cell purposes the first apparatus can actually support even when it does not relate to the one or more first inter-cell purposes.

FIG. 8 illustrates a further example, in which the first apparatus is configured with two different A4A events (or corresponding events). It is a straightforward task to implement the example to a plurality of different A4A events. Referring to FIG. 8, in the illustrated example, the first apparatus receives in block 801 from the second apparatus measurement configuration information including two sets of a criterion and a first inter-cell purpose. For example, there may be a first criterion for mTRP and a second criterion for L1 mobility.

The first apparatus performs (block 802) L3 measurements as configured until one of the first and/or second criterion is met (block 803: yes) for a corresponding inter-cell purpose. Then the first apparatus transmits in block 804 a measurement report to the second apparatus with indication of the corresponding inter-cell purpose as the second inter-cell purpose.

In the meanwhile the first apparatus continues performing (block 805) L3 measurements as configured until the other criterion is met (block 803: yes) for a corresponding other inter-cell purpose. Then the first apparatus transmits in block 807 a measurement report to the second apparatus with indication of the other corresponding other inter-cell purpose.

As can be seen from the above examples, a second inter-cell purpose may be selected by the first apparatus from the one or more first inter-cell purposes. For example, the first apparatus may be configured to indicate suitability of a non-serving cell specifically for one inter-cell purpose, or specifically for two or more inter-cell purposes, or to any of specifically indicated inter-cell purposes, or to any inter-cell purposes when no is specifically indicated. However, the first apparatus may be configured to indicate suitability of a non-serving cell for any inter-cell purpose even when configured with one or more specific inter-cell purposes.

It should be appreciated that above different examples are described using principles and terminology of 5G technology without limiting the examples to 5G.

The blocks, related functions, and information exchanges described above by means of FIGS. 2 to 8 are in no absolute chronological order, and some of them may be performed simultaneously or in an order differing from the given one. Other functions can also be executed between them or within them, and other information may be transmitted. Some of the blocks or part of the blocks or one or more pieces of information can also be left out or replaced by a corresponding block or part of the block or one or more pieces of information. Further, the different implementations described for a block may be freely combined with any of different implementations of another block.

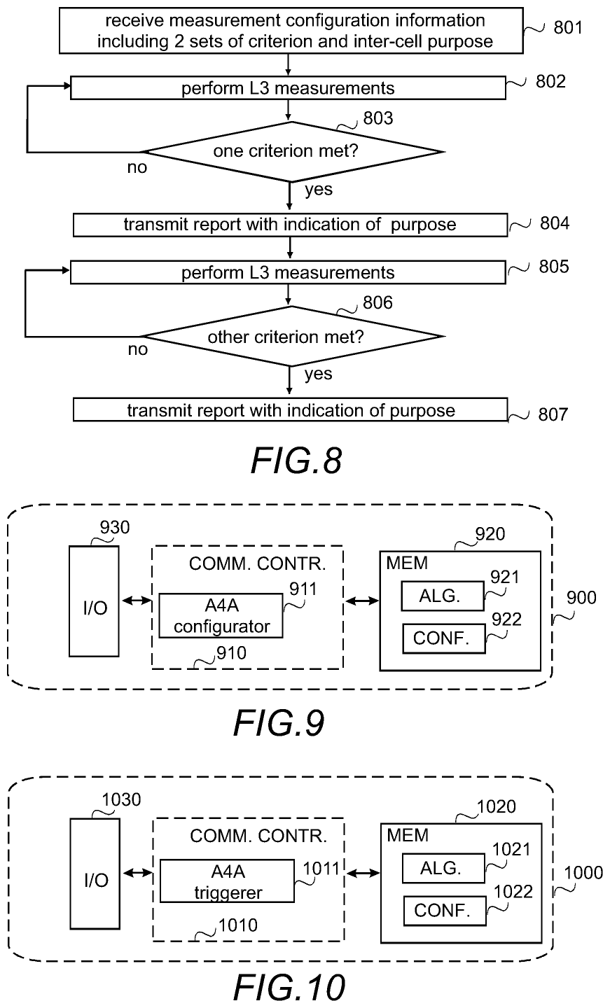

FIGS. 9 and 10 illustrate apparatuses comprising a communication controller 910, 1010 such as at least one processor or processing circuitry, and at least one memory 920, 1020 including a computer program code (software, algorithm) ALG. 921, 1021, wherein the at least one memory and the computer program code (software, algorithm) are configured, with the at least one processor, to cause the respective apparatus to carry out any one of the embodiments, examples and implementations described above. FIG. 9 illustrates a second apparatus, for example a base station or an access node, configured at least to configure first apparatuses (devices) to report one or more non-serving cells suitable for L1 measurements for one or more inter-cell purposes. FIG. 10 illustrates a first apparatus, such as a user equipment, or terminal device in a vehicle, or a vehicle, o drone, a wearable, a robot, or any other entity served by a wireless access network, to report possible non-serving cells suitable for L1 measurements for one or more inter-cell purposes as configured by the apparatus of FIG. 9. The apparatuses of FIGS. 9 and 10 may be electronic devices, further examples being listed above with FIGS. 1.

Referring to FIGS. 9 and 10, the memory 920, 1020 may be implemented using any suitable data storage technology, such as semiconductor based memory devices, flash memory, magnetic memory devices and systems, optical memory devices and systems, fixed memory and removable memory. The memory may comprise a configuration storage CONF. 921, 1021, such as a configuration database, for example for measurement configurations. The memory 920, 1020 may further store other data.

Referring to FIG. 9, the apparatus comprises a communication interface 930 comprising hardware and/or software for realizing communication connectivity according to one or more wireless and/or wired communication protocols. The communication interface 930 may provide the apparatus with radio communication capabilities with different apparatuses, for example with the apparatus of FIG. 10 and towards transmission-reception points, as well as communication capabilities towards the core network.

Digital signal processing regarding transmission and reception of signals may be performed in a communication controller 910. The communication interface may comprise standard well-known components such as an amplifier, filter, frequency-converter, (de) modulator, and encoder/decoder circuitries and a plurality of antennas.

The communication controller 910 comprises a measurement configuring circuitry 911 (A4A configurator) configured to configure first apparatuses to report one or more non-serving cells suitable for L1 measurements for one or more inter-cell purposes according to any one of the embodiments/examples/implementations described above. The measurement configuring circuitry 911 may further be configured to configure L1 measurements. The communication controller 910 may control the measurement configuring circuitry 911.

In an embodiment, at least some of the functionalities of the apparatus of FIG. 9 may be shared between two physically separate apparatuses, forming one operational entity. Therefore, the apparatus may be seen to depict the operational entity comprising one or more physically separate apparatuses for executing at least some of the processes described with the second apparatus.

Referring to FIG. 10, the apparatus 1000 may further comprise a communication interface 1030 comprising hardware and/or software for realizing communication connectivity according to one or more wireless communication protocols. The communication interface 1030 may provide the apparatus 1000 with communication capabilities with the apparatus of FIG. 9 and with transmission-reception points, for example. The communication interface may comprise standard well-known analog components such as an amplifier, filter, frequency-converter and circuitries, conversion circuitries transforming signals between analog and digital domains, and one or more antennas. Digital signal processing regarding transmission and reception of signals may be performed in a communication controller 1010.

The communication controller 1010 comprises a measurement reporting circuitry 1011 (A4A triggerer) configured to report one or more non-serving cells suitable for L1 measurements for one or more inter-cell purposes according to any one of the embodiments/examples/implementations described above. The communication controller 1010 may control the measurement reporting circuitry 1011.

As used in this application, the term ‘circuitry’ refers to all of the following: (a) hardware-only circuit implementations, such as implementations in only analog and/or digital circuitry, and (b) combinations of circuits and soft-ware (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

In an embodiment, at least some of the processes described in connection with FIGS. 2 to 8 may be carried out by an apparatus comprising corresponding means for carrying out at least some of the described processes. The apparatus may comprise separate means for separate phases of a process, or means may perform several phases or the whole process. Some example means for carrying out the processes may include at least one of the following: detector, processor (including dual-core and multiple-core processors), digital signal processor, controller, receiver, transmitter, encoder, decoder, memory, RAM, ROM, software, firmware, display, user interface, display circuitry, user interface circuitry, user interface software, display software, circuit, antenna, antenna circuitry, and circuitry. In an embodiment, the at least one processor, the memory, and the computer program code form processing means or comprises one or more computer program code portions for carrying out one or more operations according to any one of the embodiments/examples/implementations described herein.

According to yet another embodiment, the apparatus carrying out the embodiments/examples comprises a circuitry including at least one processor and at least one memory including computer program code. When activated, the circuitry causes the apparatus to perform at least some of the functionalities according to any one of the embodiments/examples/implementations of FIGS. 2 to 8, or operations thereof.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the apparatuses described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments/examples/implementations as described may also be carried out in the form of a computer process defined by a computer program or portions thereof. Embodiments of the methods described in connection with FIGS. 2 to 8 may be carried out by executing at least one portion of a computer program comprising corresponding instructions. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium, for example. Coding of software for carrying out the embodiments as shown and described is well within the scope of a person of ordinary skill in the art. In an embodiment, a computer-readable medium comprises said computer program.

It will be obvious to a person skilled in the art that, as technology advances, the inventive concept may be implemented in various ways. The embodiments are not limited to the exemplary embodiments described above, but may vary within the scope of the claims. Therefore, all words and expressions should be interpreted broadly, and they are intended to illustrate, not to restrict, the exemplary embodiments.

1. A first apparatus comprising
at least one processor; and
at least one memory including computer program code, the at least one memory and computer program code being configured to, with the at least one processor, cause the first apparatus to:
receive, from a second apparatus controlling the operation of a serving cell, Layer 3, L3, measurement configuration information including a criterion which L3 measurements of a reference signal in a non-serving cell shall meet to indicate that the non-serving cell is a suitable cell for performing Layer 1, L1 measurements by the first apparatus for one or more first inter-cell purposes;
perform L3 measurements of one or more reference signals in one or more non-serving cells;
when the criterion is met for L3 measurements of a first reference signal in a first non-serving cell, transmit a measurement report indicating that the first non-serving cell is a suitable cell for performing L1 measurements by the first apparatus for one or more second inter-cell purposes.

2. The first apparatus of claim 1, wherein the L3 measurement configuration information further includes the one or more first inter-cell purposes for which L1 measurements in the non-serving cell are usable.

3. The first apparatus of claim 1, wherein the measurement report further includes the one or more second inter-cell purposes for which L1 measurements in the first non-serving cell are usable.

4. The first apparatus of claim 2, wherein the one or more second inter-cell purposes are selected from the one or more first inter-cell purposes.

5. The first apparatus of claim 3, wherein the one or more second inter-cell purposes are selected based on capabilities of the first apparatus to operate according to the one or more second inter-cell purpose.

6. The first apparatus of claim 1, wherein the one or more first and second inter-cell purposes comprise at least one of inter-cell beam management, physical layer mobility, medium access layer mobility, and inter-cell multiple transmission-reception points.

7. The first apparatus of claim 1, wherein the at least one memory and computer program code are configured to, with the at least one processor, further cause the first apparatus to:
receive, in the measurement configuration information, a further criterion which L3 measurements of a reference signal in a non-serving cell shall meet to indicate that the non-serving cell is no longer a suitable cell for performing Layer 1, L1 measurements by the first apparatus for the one or more first inter-cell purposes;
when the further criterion is met for L3 measurements of the first reference signal, transmit a further measurement report indicating that the first non-serving cell is no longer a suitable cell for performing L1 measurements by the first apparatus for the one or more second inter-cell purposes.

8. The first apparatus of claim 1, wherein the measurement report is for reporting L3 measurements.

9. The apparatus of claim 1, wherein the first non-serving cell is configured as a candidate cell for the at least one inter-cell purposes.

10. The apparatus of claim 1, wherein the L3 measurements are configurable by means of radio resource control protocol, and/or the L3 measurements are averaged over a first time period and the L1 measurements are averaged over a second time period.

11. A second apparatus comprising
at least one processor; and
at least one memory including computer program code, the at least one memory and computer program code being configured to, with the at least one processor, cause the second apparatus to:
control the operation of a serving cell;
transmit, to a first apparatus, Layer 3, L3, measurement configuration information including a criterion which L3 measurements of a reference signal in a non-serving cell shall meet to indicate that the non-serving cell is a suitable cell for performing Layer 1, L1 measurements by the first apparatus for one or more first inter-cell purposes;
receive a measurement report indicating that the first non-serving cell is a suitable cell for performing L1 measurements by the first apparatus for one or more second inter-cell purposes.

12. The second apparatus of claim 11, wherein the L3 measurement configuration information further includes the one or more first inter-cell purposes for which L1 measurements in the non-serving cell are usable.

13. The second apparatus of claim 11, wherein the measurement report further includes the one or more second inter-cell purposes for which L1 measurements in the first non-serving cell are usable.

14. The second apparatus of claim 11, wherein the at least one memory and computer program code are configured to, with the at least one processor, further cause the second apparatus to:
transmit, in the measurement configuration information, a further criterion which L3 measurements of a reference signal in a non-serving cell shall meet to indicate that the non-serving cell is no longer a suitable cell for performing Layer 1, L1 measurements by the first apparatus for the one or more first inter-cell purposes;
receive a further measurement report indicating that the first non-serving cell is no longer a suitable cell for performing L1 measurements by the first apparatus for the one or more second inter-cell purposes.

15. A method comprising:
receiving, in a first apparatus, from a second apparatus controlling the operation of a serving cell, Layer 3, L3, measurement configuration information including a criterion which L3 measurements of a reference signal in a non-serving cell shall meet to indicate that the non-serving cell is a suitable cell for performing Layer 1, L1 measurements by the first apparatus for one or more first inter-cell purposes;
performing by the first apparatus L3 measurements of one or more reference signals in one or more non-serving cells;
when the criterion is met for L3 measurements of a first reference signal in a first non-serving cell, transmitting from the first apparatus a measurement report indicating that the first non-serving cell is a suitable cell for performing L1 measurements by the first apparatus for one or more second inter-cell purposes.

16. (canceled)
